(19) United States
(12) Patent Application Publication
(10) Pub. No.: US 2013/0130058 A1
(43) Pub. Date: May 23, 2013

(54) AUSTENITIC STAINLESS STEEL

(71) Applicants: Atsuro ISEDA, Kobe-shi (JP); Yoshitaka Nishiyama, Nishinomiya-shi (JP); Masahiro Seto, Nisinomiya-shi (JP); Satomi Yamamoto, Sanda-shi (JP); Hiroyuki Hirata, Nayagawa-shi (JP); Yasutaka Noguchi, Takarazuka-shi (JP); Mitsuru Yoshizawa, Amagosaki-shi (JP); Hiroshi Matsuo, Nishinomiya-shi (JP)

(72) Inventors: Atsuro ISEDA, Kobe-shi (JP); Yoshitaka Nishiyama, Nishinomiya-shi (JP); Masahiro Seto, Nisinomiya-shi (JP); Satomi Yamamoto, Sanda-shi (JP); Hiroyuki Hirata, Nayagawa-shi (JP); Yasutaka Noguchi, Takarazuka-shi (JP); Mitsuru Yoshizawa, Amagosaki-shi (JP); Hiroshi Matsuo, Nishinomiya-shi (JP)

(73) Assignee: SUMITOMO METAL INDUSTRIES, LTD., Osaka (JP)

(21) Appl. No.: 13/429,966

(22) Filed: Mar. 26, 2012

Related U.S. Application Data
(63) Continuation of application No. PCT/JP2011/076701, filed on Nov. 18, 2011.

(51) Int. Cl. B32B 15/01

(52) U.S. Cl. 428/638

(57) ABSTRACT

To provide an austenitic stainless steel which has an excellent high-temperature corrosion thermal fatigue cracking resistance.

An austenitic stainless steel containing, by mass %, Cr: 15.0 to 23.0%, and Ni: 6.0 to 20.0%, wherein a near-surface portion is covered with a worked layer with high energy density having an average thickness of 5 to 30 μm.

The disclosure of International Application No. PCT/JP2011/076701 filed Nov. 18, 2011 including specification, drawings and claims is incorporated herein by reference in its entirety.

### TECHNICAL FIELD

The present invention relates to austenitic stainless steel.

### BACKGROUND ART

Patent Document 1 discloses an austenitic stainless steel tube having an excellent high-temperature strength and corrosion resistance, which is used, among others, in existing thermal power generation boilers that burn coals and the like.

Patent Document 2 discloses a method for preventing the exfoliation of scale layer produced by steam oxidation, in an environment where a material is subject to thermal stress due to cycles of heating and cooling, by defining the surface condition and hardness of the material which has undergone cold working such as shotpeening on the inner surface of tube.

Patent Document 3 discloses an invention in which the area of the inner surface of a tube to be subjected to shotpeening is not less than 70% in visual coverage to improve its steam oxidation resistance.

Patent Document 4 discloses an invention in which the hardness of the near-surface portion and the hardness of the inner portion of the inner surface of a tube are within a specific range by applying shotpeening to improve its steam oxidation resistance.
[Patent Document 1] JP2003-268503A
[Patent Document 2] JP2006-307313A
[Patent Document 3] WO2007/099949
[Patent Document 4] JP2009-68079A

### DISCLOSURE OF THE INVENTION

### Problems to be Solved by the Invention

In a gas turbine combined power generation which has been recently commercialized, a heat recovery steam generator (hereafter referred to as an “HRSG”) which recovers the heat of the exhaust gas of a gas turbine and circulates steam having a temperature of not less than 500° C. is used. The heat exchanger tube used therein is subject to corrosion by steam oxidation, and is also subject to cyclic thermal fatigue in a larger temperature range than ever. Moreover, in heat exchanger members (tubes, pipes, plates, forgings) of next generation solar thermal power generation, since the concentrated solar power significantly varies depending on the weather, the materials used therein are also subject to severe corrosion such as atmospheric oxidation, etc. and is also subject to thermal fatigue at a higher cyclic load level.

Thus, in the use environment of heat exchanger members for HRSG or next generation solar power generation, which is quite different from in conventional thermal power generation boilers, thermal expansion/contraction due to severe temperature changes and high-temperature corrosion are coupled with each other so that a thermal fatigue cracking (hereafter, this is referred to as a “high-temperature corrosion thermal fatigue cracking”) have become a large bottleneck.

The reason of this is that a conventional high-strength austenitic stainless steel has a thermal expansion which is 1.3 times larger than that of a carbon steel, a carbon steel, or a 9Cr steel, and further that it is used at higher temperatures than before. That is, as the temperature of steam increases, the temperature difference in a use environment has been increasing and when the thermal expansion difference experienced by a member increases, the degree of thermal fatigue caused by that will also increase. Further, if corrosion of a heat exchanger tube occurs at a higher temperature, thermal fatigue cracking due to thermal expansion difference may be increasingly promoted. Such cracking has not been a problem at all in conventional power generation boilers and is a phenomenon which has not even been taken into consideration.

In a broad sense, as the restriction and prevention of cracking due to fatigue, there is a technique to introduce compressive residual stress in the surface layer of material by means of surface cold working such as shotpeening. However, this method, which is based on the introduction of a slight compressive residual stress (residual compressive strain), will easily loose its effects at a high temperature of not lower than 500° C. becoming unable to withstand uses.

In the invention of Patent Document 1, although high-temperature strength and corrosion resistance (including steam oxidation resistance) are taken into consideration, no consideration is given to thermal fatigue cracking coupled with high-temperature corrosion which is requisite in the present invention. Even if high-temperature strength and corrosion resistance are high, those by themselves are not effective against thermal fatigue cracking coupled with high temperature corrosion.

The invention of Patent Document 2 has its objective to restrict the exfoliation of scale, and what is formed thereby is only a worked layer which is worked to a level at which crystal grain boundaries and crystal grains are discriminable. The worked layer to be obtained by the inventions of Patent Documents 3 and 4 are also similar A worked layer having such a lower energy density cannot prevent cracking due to high-temperature corrosion thermal fatigue.

It is an objective of the present invention to provide an austenitic stainless steel and a steel tube, which can prevent cracking due to high-temperature corrosion thermal fatigue which becomes a problem in the steel to be used in a high-temperature corrosive (e.g. oxidation) environment not less than 500° C. and an environment associated with thermal fatigue cycles between normal temperature and high temperature.

### Means for Solving the Problems

The present inventors have conducted detailed analysis on thermal fatigue cracking associated with high-temperature corrosion to develop a revolutionary technique for preventing cracking by high-temperature corrosion thermal fatigue which occurs in new type boilers such as HRSGs or those for next generation solar power generation, consequently obtaining the following new findings.

1) Thermal fatigue cracking associated with high-temperature corrosion occurs at crystal grain boundaries. This is because there is difference in deformability between the inside of crystal grain and the crystal grain boundary, and cracking (a micro-crack) occurs at a crystal grain boundary where strain and stress concentrate.

2) The propagation of cracking (a crack) is not due to simple thermal fatigue, but due to thermal stress and strain caused by a cyclic temperature change associated with corrosion such as oxidation etc. at the front end of cracking.

3) It is quite impossible to stop the occurrence of such corrosion thermal fatigue cracking and the propagation of the crack by the above described shotpeening process of prior art.

The present inventors have conducted further studies based on the above described findings and have obtained the following findings.

4) It is needed that the steel material has a chemical composition that allows a Cr (chromium) oxide film to be produced at the front end of cracking (a micro-crack) that occurs at a crystal grain boundary. Moreover, it is effective that the steel material has a fine grain micro-structure.

5) To prevent the occurrence of the above described micro-crack, it is necessary to provide a layer (a worked layer with high energy density), on the surface of the steel material, which is worked at a high energy density so that the micro-structures of crystal grain boundaries and crystal grains are crushed so as to be indistinguishable. Since this allows, the difference in plastic deformation due to thermal fatigue to be eliminated, it becomes possible to prevent the occurrence of a micro-crack which acts as the starting point for a crack.

6) The worked layer with high energy density allows the release of the stain at a crack front end to be promoted even when a micro-crack occurs to grow into a crack, and the Cr oxide film produced at the front end of cracking can prevent further propagation of cracking due to corrosion.

7) A worked layer with high energy density appears as a gray-level difference in the microscopic observation of a specimen including the worked layer, after it is heated at 650 to 750° C. for 10 minutes to 10 hours, a cross section thereof including the worked layer is ground, and thereafter the ground surface is electrolytic etched in a 5 to 20% solution of chromic acid. That is, it is possible to visualize a worked layer with high energy density by subjecting it to electrolytic etching after a heat-sensitization heat treatment.

The present invention has been made based on such findings and the gist thereof lies in the following austenitic stainless steel and austenitic stainless steel tube.

(1) An austenitic stainless steel containing, by mass %, Cr: 15.0 to 23.0%, and Ni: 6.0 to 20.0%, wherein a near-surface portion is covered with a worked layer with high energy density having an average thickness of 5 to 30 μm.

(2) An austenitic stainless steel, comprising a chemical composition consisting of, by mass %, C: 0.02 to 0.15%, Si: 0.1 to 1.0%, Mn: 0.1 to 2.0%, Cr: 15.0 to 23.0%, Ni: 6.0 to 20.0%, and N: 0.005 to 0.3%, and one or more kinds selected from Co: not more than 0.8%, Cu: not more than 5.0%, V: not more than 1.5%, Nb: not more than 1.5%, sol. Al: not more than 0.05%, and B: not more than 0.03%, the balance being Fe and impurities, P and S which are impurities being not more than 0.04% and not more than 0.03%, respectively, wherein a near-surface portion is covered with a worked layer of high energy density having an average thickness of 5 to 30 μm.

(3) The austenitic stainless steel according to the above described (1) or (2), containing, by mass %, in place of part of Fe, one or more elements selected from following first and second groups:

the first group: Ca: not more than 0.2%, Mg: not more than 0.2%, Zr: not more than 0.2%, REM: not more than 0.2%; and

the second group: Ti: not more than 1.0%, Ta: not more than 0.35%, Mo: not more than 4.0%, and W: not more than 8.0%.

(4) The austenitic stainless steel according to any of the above described (1) to (3), wherein the austenitic stainless steel has an average creep rupture strength of not less than 85 MPa at 700° C. for 10000 hours.

(5) The austenitic stainless steel according to any of the above described (1) to (4), wherein the austenitic stainless steel has an austenite grain size number of not less than seven.

(6) The austenitic stainless steel according to any of the above described (1) to (5), wherein a thickness of the worked layer is represented by a thickness which appears as a gray level difference in a microscopic observation of the austenitic stainless steel, after the austenitic stainless steel is heated at 650 to 750° C. for 10 minutes to 10 hours, a cross section thereof including the worked layer is polished, and thereafter the polished surface is electroetched in a 5 to 20% chromic acid solution.

(7) The austenitic stainless steel according to any of the above described (1) to (6), wherein the austenitic stainless steel is used as a heat-resisting member.

(8) An austenitic stainless steel tube comprised of the steel according to any of the above described (1) to (7).

### Advantage of the Invention

According to the present invention, it is possible to provide an austenitic stainless steel which can withstand an environment subject to high-temperature corrosion at not less than 500° C. and a cyclic thermal fatigue, that is, which has an excellent high-temperature corrosion thermal fatigue cracking resistance. Accordingly, the austenitic stainless steel of the present invention is optimal for heat exchanger members of HRSG or next generation solar power generation. Of course, the austenitic stainless steel of the present invention is also suitable for applications in which heat resisting properties are particularly required, such as tubes, pipes, plates, bars, and forgings used in heat resistant pressurized parts for general power generation boilers, chemical industries, and nuclear power facilities, etc. Further, the austenitic stainless steel of the present invention can also be applied to common thermal power generation boilers and heat exchanger materials for chemical industries and nuclear power facilities.

### BRIEF DESCRIPTION OF DRAWINGS

FIG. 1 is an optical microscopic micro-structure of a steel tube having a surface worked layer with high energy density.

FIG. 2 is an optical microscopic micro-structure of a steel tube not having a surface worked layer with high energy density.

### BEST MODE FOR CARRYING OUT THE INVENTION

### 1. Chemical Composition

First, the reason why the chemical composition of the austenitic stainless steel of the present invention is determined will be described in detail. Hereafter, “%” regarding the content means “mass %”.

An austenitic stainless steel of the present invention contains Cr: 15.0 to 23.0%, and Ni: 6.0 to 20.0%.

Cr: 15.0 to 23.0%

Cr (chromium) is an essential element to secure oxidation resistance and corrosion resistance. Moreover, in order to prevent the crack propagation of corrosion thermal fatigue cracking which is the main focus of the present invention, a film of Cr oxide must be produced on a crack front end portion. The minimum amount of Cr that is necessary for corrosion resistance and corrosion fatigue cracking prevention for austenitic stainless steel is 15.0% under a high-temperature (about 500 to 800° C.) steam condition. As the amount of Cr increases, the production of the above described Cr oxide film on crack front end for corrosion resistance and cracking resistance increases. However, if the Cr content exceeds 23.0%, a brittle sigma phase is produced thereby deteriorating metal micro-structure and drastically reducing creep ductility and weldability. Therefore, the Cr content is determined to be 15.0 to 23.0%. A lower limit of Cr content is preferably 16.0%, and more preferably 17.0%. Moreover, an upper limit thereof is preferably 20.0%, and more preferably 19.0%.

Ni: 6.0 to 20.0%

Ni (nickel) stabilizes austenitic micro-structure and serves to prevent the occurrence of brittle sigma phase, etc. While the content thereof may be determined in balance with the amounts of other ferrite forming elements including Cr, it is necessary that not less than 6.0% of Ni is contained in order to secure the strength and corrosion resistance in high-temperature usage. However, if the content thereof exceeds 20.0%, the cost will increase and corrosion thermal fatigue cracking resistance will be rather impaired. Therefore, the Ni content is determined to be 6.0 to 20.0%. A lower limit of Ni content is preferably 8.0%, and more preferably 8.5%. Moreover, an upper limit thereof is preferably 15.0%, and more preferably 13.0%.

The austenitic stainless steel of the present invention preferably has a chemical composition consisting particularly of, by mass %, C: 0.02 to 0.15%, Si: 0.1 to 1.0%, Mn: 0.1 to 2.0%, Cr: 15.0 to 23.0%, Ni: 6.0 to 20.0% and N: 0.005 to 0.3%, and one or more kinds selected from Co: not more than 0.8%, Cu: not more than 5.0%, V: not more than 1.5%, Nb: not more than 1.5%, sol. Al: not more than 0.05%, and B: not more than 0.3%, the balance consisting of Fe and impurities, wherein P, which is an impurity, is not more than 0.04% and S is not more than 0.03%.

It is noted that the impurities refers to components which are mixed into a steel material from raw materials such as ores and scraps, etc. or by other causes while the steel material is commercially manufactured.

The ranges of preferable contents of elements other than Cr and Ni, and the limiting reason for them are as follows.

C: 0.02 to 0.15%

C (carbon) is effective in forming carbides such as V, Ti, Nb, Cr and so on to increase the high-temperature tensile strength and high-temperature creep strength. To achieve such advantages, C is preferably contained by not less than 0.02%. However, if the C content exceeds 0.15%, there is a risk that undissolved carbides occur or the carbide of Cr increase thereby deteriorating weldability. Thus, it is preferred that the content of C be 0.02 to 0.15%. A more preferable lower limit thereof is 0.03%, and a more preferable upper limit thereof is 0.12%.

Si: 0.1 to 1.0%

Si (silicon) is an element which has a deoxidation agent and can improve oxidation resistance and corrosion resistance. To achieve such advantages, Si is preferably contained by not less than 0.1%. However, if its content exceeds 1.0%, a sigma phase is produced at high temperatures thereby deteriorating workability and degrading the stability of metal micro-structure. Therefore, it is preferred that the content of Si be 0.1 to 1.0%. From the viewpoint of the stability of metal micro-structure, Si is preferably contained by not more than 0.5%.

Mn: 0.1 to 2.0%

Mn (manganese) is an element effective in forming MnS (sulfide) and thereby improves hot workability. To achieve such advantages, Mn is preferably contained by not less than 0.1%. However, if its content exceeds 2.0%, there is a risk that the material becomes hard and brittle thereby impairing workability and weldability. Accordingly, it is preferred that the content of Mn be 0.1 to 2.0%. A more preferable lower limit thereof is 0.5% and a more preferable upper limit is 1.5%.

N: 0.005 to 0.3%

N (nitrogen) is effective in securing high-temperature strength by such as precipitation strengthening by carbo-nitrides, etc. and the stability of metal micro-structure. To achieve such advantages, N is preferably contained by not less than 0.005%. However, if N is contained by not less than 0.3%, carbo-nitrides increase causing a risk that cracking during hot working and welding are induced thus impairing corrosion thermal fatigue cracking resistance. Accordingly, it is preferred that the content of N be 0.005 to 0.3%. A more preferable lower limit thereof is 0.01%, and a more preferable upper limit thereof is 0.2%.

Co: not more than 0.8%

Co (cobalt) is an element effective in contributing to the stability of austenitic micro-structure. However, its content is preferably not more than 0.8% because there is a problem such as contamination in the furnace in steel making. A more preferable upper limit thereof is 0.5%. To achieve the above described advantage, it is preferred that Co be contained by not less than 0.01%.

Cu: not more than 5.0%

Cu (copper) is an element which contributes to high-temperature strength as a precipitation strengthening element. However, if its content exceeds 5%, creep ductility may be severely decreased. Accordingly, it is preferred that the content of Cu be not more than 5%. A more preferable upper limit thereof is 4%. To achieve the above described advantage, it is preferred that the content of Cu be not less than 0.01%. A more preferable lower limit thereof is 1%.

V: not more than 1.5%

V (vanadium) is an effective element in forming a carbo-nitride by itself and dissolving into Cr carbides to stabilize the morphology thereof, thereby increasing creep strength. It is also effective in improving corrosion thermal fatigue resistance. However, when exceeding 1.5%, V will turn into inclusions during steel making causing a risk of deteriorating workability and weldability. Accordingly, it is preferred that the content of V be not more than 1.5%. A more preferable upper limit thereof is 1.0% and further preferable upper limit thereof is 0.5%. To achieve the above-described advantages, it is preferred that V be contained by not less than 0.01%. A more preferable lower limit thereof is 0.02%.

Nb: not more than 1.5%

Nb (niobium) is effective in forming a carbo-nitride thereby increasing creep strength. Moreover, it is also an element which stabilizes carbides which prevent stress corrosion cracking (SCC). Further, Nb also contributes to the grain refinement of metal micro-structure. However, if its content is excessive, there is a risk that Nb deteriorates hot workability and weldability. Accordingly, it is preferred that the content of Nb be not more than 1.5%. A more preferable upper limit thereof is 1.0%. To achieve the above described advantages, it is preferred that Nb be contained by not less than 0.05%. A more preferable lower limit thereof is 0.2%.

sol. Al: not more than 0.05%

Al (aluminum) is an element effective for deoxidation, and is also an element effective to remove non-metallic inclusions and stabilize the steel quality. However, excessive content of Al will increase non-metallic inclusions, thereby reducing creep strength and impairing fatigue property and toughness. Therefore, it is preferred that sol. Al (soluble Al) be contained by not more than 0.05%. A more preferable upper limit thereof is not more than 0.03%. To achieve the above described advantages, it is preferred that Al be contained by not less than 0.003%.

B: not more than 0.03%

B (boron) is an element which increases high temperature creep strength. However, if the content of B is excessive, there is a risk that cracking during manufacturing of a thick-wall member and cracking during welding work are induced. Therefore, it is preferred that the content of B be not more than 0.03%. A more preferable upper limit thereof is 0.008%. To achieve the above described advantage, it is preferred that B be contained by not less than 0.0005%. A more preferable lower limit is 0.001%.

P: not more than 0.04%

P (phosphorus) is an element which is mixed into the steel material as an impurity, and its content is preferably as little as possible since it harms weldability and workability. According, it is preferred that the upper limit of P be 0.04%. A more preferable upper limit thereof is 0.03%.

S: not more than 0.03%

S (sulfur) is an element which is mixed into the steel material as an impurity, and its content is preferably as little as possible since it harms weldability and workability. Accordingly, it is preferred that the upper limit of S be 0.03%. A more preferable upper limit thereof is 0.01%.

The austenitic stainless steel of the present invention may contain, in place of part of Fe, one or more elements selected from Ca: not more than 0.2%, Mg: not more than 0.2%, Zr: not more than 0.2%, REM: not more than 0.2%, Ti: not more than 1.0%, Ta: not more than 0.35%, Mo: not more than 4.0%, and W: not more than 8.0%.

Ca: not more than 0.2%

Mg: not more than 0.2%

Zr: not more than 0.2%

REM: not more than 0.2%

Each of these elements is an element which improves strength, workability, and oxidation resistance. Moreover, each of them also has an effect of combining with harmful impurities such as P and S thereby resolving the harmfulness thereof. Further, they have an effect of controlling the morphology of various precipitates to make them finely dispersed or stabilized at a high temperature for long hours. Accordingly one or more elements of these may be contained. However, even if they are excessively contained, the advantages thereof may be saturated while the cost is raised, and also there is a risk that these elements conversely impair toughness, workability, and weldability as impurities during steel making. Accordingly, it is preferred that the upper limit of content of each element be 0.2%. To achieve the above described advantages, it is preferred that each element be contained by not less than 0.0001%. Although these elements may be contained in combination of multiple kinds, it is preferred that the total content of such a case be not more than 0.3%.

It is noted that REM is a general term of a total of 17 elements including Sc, Y and Lanthanoids, and the content of REM means the total amount of the above described elements.

Ti: not more than 1.0%

Ti (titan) is an effective element in forming a carbo-nitride and improving the strength of steel by precipitation strengthening. Moreover, as with Nb, Ti is also an element to stabilize carbides which prevent SCC. However, if it is contained by more than 1.0%, the inclusions during steel making increase and may thereby impair the strength, toughness, weldability and thermal fatigue resistance. Accordingly, it is preferred that the upper limit of Ti content be 1.0%. A more preferable upper limit thereof is 0.8%. To achieve the above described advantages, it is preferred that Ti be contained by not less than 0.001%.

Ta: not more than 0.35%

Ta (tantalum) is an element which forms a carbide and improves the strength of steel by precipitation strengthening. However, if Ta is contained by more than 0.35%, there is a risk that hot workability is impaired and welding cracking susceptibility is increased. Accordingly, it is preferred that the upper limit of Ta content be 0.35%. To achieve the above described advantage, it is preferred that Ta be contained by not less than 0.01%.

Mo: not more than 4.0%

Mo (molybdenum) is an element which improves high-temperature strength and corrosion resistance. However, if the content of Mo exceeds 4.0%, a brittle phase during high temperature usage increases causing a risk that workability, weldability, strength, and thermal fatigue resistance are impaired. Accordingly, it is preferred that the upper limit of Mo be 4.0%. A more preferable upper limit thereof is 3.5%. To impart strength, Mo is preferably contained by not less than 0.1%. A more preferable lower limit thereof is 2.0%. When both Mo and W are contained, it is preferred that Mo+½W be 2.0 to 4.0%.

W: not more than 8.0%

W (tungsten) is, as with Mo, an element which improves high-temperature strength and corrosion resistance. However, if the content thereof exceeds 8.0%, a brittle phase during high temperature usage increases causing a risk that workability, weldability, strength, and thermal fatigue resistance are impaired. Accordingly, it is preferred that the upper limit of W be 8.0%. A preferable upper limit thereof is 7.0%. To impart strength, W is preferably contained by not less than 0.1%. A preferable lower limit thereof is 2.0%.

### 2. Worked Layer with High Energy Density

A worked layer with high energy density is, as described above, a layer on the surface of the steel material, which is worked at a high energy density so that the micro-structures of crystal grain boundaries and crystal grains are crushed so as to be indistinguishable. Since this layer is a special worked layer in which the difference in plastic deformation between the crystal grain boundary and the grain is eliminated, it becomes possible to prevent a micro-crack which occurs at a crystal grain boundary and acts as the starting point for a crack in thermal fatigue coupled with high-temperature corrosion. Moreover, since the layer has an effect of releasing the concentration of strain and also an effect of facilitating the diffusion of Cr, it is more likely that Cr moves to the surface layer of the steel material from inside the base metal and a film of Cr oxide is produced on a crack front end portion. As a result of this, even if a micro-crack is produced, the layer can prevent the propagation of the crack. Such advantageous effect cannot be achieved by a conventional simple worked layer of high dislocation density.

It is needed that the thickness of the worked layer with high energy density be in average in the range of 5 to 30 μm. With the thickness being less than 5 μm, the above described advantage cannot be achieved and fine cracks are likely to occur. On the other hand, with the thickness being more than 30 μm, the material becomes too hard so that the bending and welding thereof become difficult. Moreover, it is difficult to obtain a worked layer with high energy density having a thickness of more than 30 μm by a common method in an industrial sense.

Herein, the average thickness of a worked layer with high energy density can be determined performing the below described (1) to (5) in order.

(1) Perform a sensitization treatment in which the austenitic stainless steel is heated at 650 to 750° C. for 10 minutes to 10 hours.

(2) Polish a vertical cross section including a worked layer.

(3) Perform electro etching of the polished cross section including the worked layer in a 5 to 20% solution of chromic acid at 0.5 to 2 A/cm² for 10 to 300 seconds. In the case of a material having a high corrosion resistance, since it is not likely to be etched, the etching may be performed repeatedly while observing the metal micro-structure.

(4) Observe the gray level difference of the cross section including the worked layer by a microscope. At this moment, a darker portion is defined to be a “worked layer with high energy density”.

(5) Measure the thicknesses of the worked layer with high energy density for 10 fields of view to take an average of them.

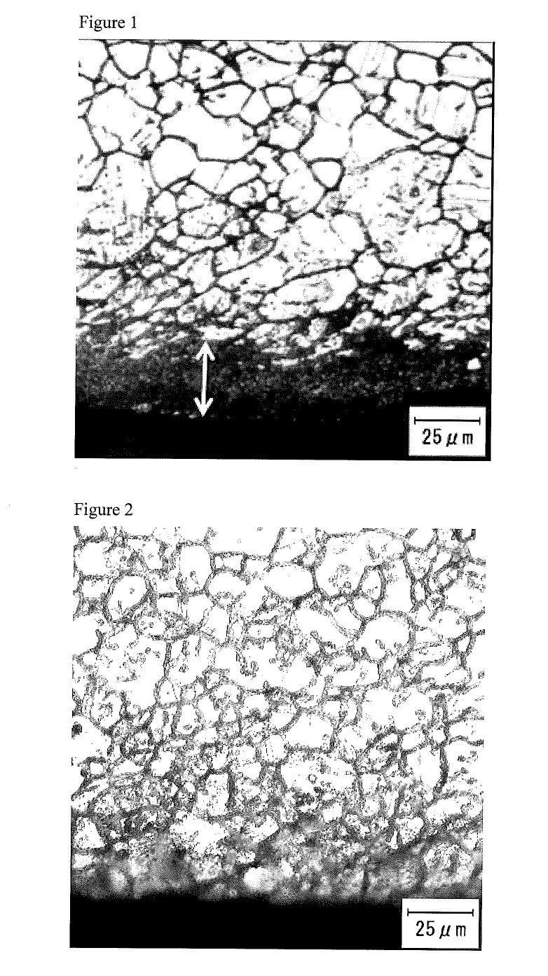

As shown in FIG. 1, a darker portion in the observed cross section, that is, a layer (shown by the arrow in the figure) in which the inside of crystal grain and the crystal grain boundary are indistinguishable is a worked layer with high energy density. Moreover, above the worked layer with high energy density, there is a normal worked layer in which crystal grain boundaries and crystal grains are clear and which has twin bands and a high dislocation density; however, this layer is not a worked layer with high energy density. In contrast to this, as shown in FIG. 2, there is no worked layer with high energy density in a material which has not been subjected to shotpeening process under a predetermined condition.

### 3. Manufacturing Process

A worked layer with high energy density can be obtained by whatever processes including surface working methods such as by shotpeening, cold working, hammering, etc., ultrasonic irradiation methods, laser shot methods, and so on. However, to eliminate the distinction between the crystal grain boundary and the crystal grain, it is necessary to perform a fine surface working with very high energy density. To be specific, for example, in the case of shotpeening, it is important to achieve a working with high energy density by using shot balls of an appropriate hard material, size, and shape, and optimizing the conditions of ejection angle, flow amount, flow rate, opening of nozzle for causing shot balls to intensively collide with the surface to be worked.

### 4. Creep Strength

The austenitic stainless steel relating to the present invention is targeted to heat exchanger tubes of HRSG or next generation solar thermal power generation, and in addition to that, heat exchanger tubes for use in conventional thermal power generation boilers, and it preferably has an average creep rupture strength of not less than 85 MPa at 700° C. for 10000 hours. The austenitic stainless steel to be used under the above described environment will be exposed to a temperature range of not less than 500° C. for a long period as long as one hundred thousands to four hundred thousands hours. Therefore, it will not be able to withstand under such environment when its average creep rupture strength is less than 85 MPa at 700° C. for 10000 hours.

### 5. Crystal Grain Size

To secure corrosion thermal fatigue cracking resistance, it is crucial that even if a cracking occurs, a Cr oxide film is immediately formed at the front end portion of the cracking, and in order for that, it is effective to make the base metal be fine grain micro-structure. To be specific, it is preferred that the grain size number of metal micro-structure measured according to JIS G 0551 be No. 7 or higher.

### Examples

A steel ingot having a chemical composition shown in Table 1 was melted by a 180 kg vacuum furnace and formed into a seamless steel tube test material by hot forging and hot extrusion. A, B and C steels were, after extrusion, subjected to softening treatment at 1250° C. and cold drawing, and were further subjected to final solution treatment at 1200° C. to be formed into a steel tube having an outer diameter of 45 mm and a wall thickness of 8 mm. D, E and F steels were subjected to a final solution treatment at 1200° C. as a hot finishing to be formed into a steel tube having an outer diameter of 45 mm and a wall thickness of 8 mm.

TABLE 1

| Steel | Chemical Composition (mass % the balance being Fe and impurity) | | | | | | | | | | | | | |
|---|---|---|---|---|---|---|---|---|---|---|---|---|---|---|
| No. | C | Si | Mn | P | S | Cr | Ni | Cu | V | Nb | sol. Al | B | N | Others |
| A | 0.08 | 0.45 | 1.45 | 0.028 | 0.002 | 18.52 | 9.17 | 2.95 | 0.04 | 0.53 | 0.008 | 0.0035 | 0.123 | Co: 0.04 |
| B | 0.07 | 0.25 | 1.23 | 0.013 | 0.001 | 18.34 | 12.45 | — | 0.07 | 0.92 | 0.015 | — | 0.045 | Ca: 0.0005, Mg: 0.0003 |
| C | 0.09 | 0.23 | 1.28 | 0.015 | 0.001 | 17.85 | 8.92 | 0.03 | 0.38 | 0.78 | 0.002 | 0.0037 | 0.106 | Co: 0.03, Nd: 0.02 |
| D | 0.03 | 0.42 | 1.67 | 0.031 | 0.003 | 18.79 | 14.73 | — | 0.02 | — | 0.007 | 0.0021 | 0.176 | Mo: 0.5, W: 2.0, Co: 0.05 |
| E | 0.12 | 0.36 | 0.77 | 0.038 | 0.002 | 16.89 | 12.24 | — | — | — | 0.011 | 0.0015 | 0.058 | Ti: 0.8 |
| F | 0.12 | 0.45 | 0.56 | 0.035 | 0.007 | 13.74* | 5.37* | — | — | 0.45 | 0.025 | — | 0.015 | — |

*means it does not meet the claimed range.

A shotpeening processing was applied to the inner surface of the obtained steel tubes at two different conditions: A and B. “A” shows an example of the worked layer which was obtained by performing a working in which ordinary shot balls were uniformly hit onto the tube inner surface so that the hardness at a depth of 40 μm from the inner surface was a value of the level that is higher than the average hardness of base material by not less than 50 in the difference of Vickers hardness (ΔHv). “B” shows an example of the worked layer with the high energy density which was obtained by performing a—working in which a nozzle of which spray aperture was narrowed to increase the spraying velocity was used to locally spray shot balls of an amount twice as much as that of A onto the tube inner surface so that the micro-structure was crushed until the distinction between the crystal grain boundary and the crystal grain was eliminated.

<Thickness of Worked Layer with High Energy Density>

To visualize the worked layer, each test specimen was subjected to the below described sensitization treatment at 700° C. for one hour, and a cross section including the worked layer was polished and thereafter subjected to electroetching at 1 A/cm² for 70 sec in a 10% solution of chromic acid. The gray level difference of the cross section including the worked layer was observed by a microscope, and assuming that a darker portion is a “worked layer with high energy density”, the thickness thereof was measured in five fields of view. The results thereof are shown in Table 2.

### <Crystal Grain Size of Base Metal>

An average grain size number at a central portion of tube wall thickness was investigated according to JIS G 0551. The results thereof are listed together in Table 2.

### <Creep Rupture Strength>

A round-bar tensile test specimen having an outer diameter of 6 mm and a parallel part of 30 mm was sampled from a central portion of tube wall thickness, and a rupture strength at ten thousands hours was determined by averaging the results of the test for three pieces each with varied stresses including a creep rupture test at 700° C. for more than ten thousands hours at maximum. The results thereof are listed together in Table 2.

### <Thermal Fatigue Test>

First, each test material was subjected to the preparation of a weld groove with an inclination of 60 degrees as it is in a tube form, and then to peripheral welding to form a weld joint with an extra thickness (ER NiCr-3 was used as the welding material), and thereafter the weld joint was subjected to cycles of rapid heating by high frequency and air cooling (rapid cooling), thereby being exposed to atmospheric oxidation and thermal fatigue. The heating/cooling was repeated for 5000 cycles between 650° C. and 100° C. The resultant each test material was observed with an optical microscope to investigate the presence or absence of corrosion thermal fatigue cracking of the inner surface shotpeening worked layer in tube longitudinal cross section. When there is a crack of 5 μm or larger, it is determined that “cracking is present”. The results are listed together in Table 2. Moreover, the microphotographs of test material No. 2 (the present invention) and No. 1 (prior art) are shown in FIGS. 1 and 2, respectively.

TABLE 2

| | | | Thickness | | | |
|---|---|---|---|---|---|---|
| | | | of worked | | | |
| | | | layer | Crytal | | |
| | | | of high | grain | Creep | |
| Test | | | energy | size of | rupture | |
| Material | Steel | conditions of | density | base | strength | |
| No. | No. | Shotpeening | (μm) | metal | (MPa) | cracks |
| 1 | A | A | 0* | 8.2 | 112 | presence |
| 2 | A | B | 25 | 8.2 | 112 | absence |
| 3 | B | A | 0* | 9.3 | 90 | presence |
| 4 | B | B | 8 | 9.3 | 90 | absence |
| 5 | C | B | 15 | 7.5 | 105 | absence |
| 6 | D | B | 22 | 4.1 | 123 | absence |
| 7 | E | B | 22 | 4.5 | 87 | absence |
| 8 | F* | B | 27 | 3.7 | 65 | presence |

*means it does not meet the claimed range.

As shown in Table 2, since test materials No. 1 and No. 3 did not have a worked layer with high energy density (thickness of 0 μm), thermal fatigue cracking occurred therein. Further, since test material No. 8 had a low amount of Cr, a thermal fatigue cracking could not be prevented even though a worked layer with high energy density was formed.

On the other hand, since test materials 2, 4, 5, 6 and 7 satisfied the chemical composition defined in the present invention, and had a worked layer with high energy density having a thickness defined in the present invention, there was no thermal fatigue cracking

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

According to the present invention, it is possible to provide an austenitic stainless steel which can withstand an environment subject to high-temperature corrosion at not less than 500° C. and a cyclic thermal fatigue, that is, which has an excellent high-temperature corrosion thermal fatigue cracking resistance. Accordingly, the austenitic stainless steel of the present invention is optimal for heat exchanger members of HRSG or next generation solar power generation. Of course, the austenitic stainless steel of the present invention is also suitable for applications in which heat resisting properties are particularly required, such as tubes, pipes, plates, bars, and forgings used in heat resistant pressurized parts for general power generation boilers, chemical industries, nuclear power facilities, etc. Further, the austenitic stainless steel of the present invention can also be applied to common thermal power generation boilers and heat exchanger materials for chemical industries and nuclear power facilities.

1. Austenitic stainless steel, comprising, by mass %, Cr: 15.0 to 23.0%, and Ni: 6.0 to 20.0%, wherein
a surface area is covered with a worked layer with high energy density having an average thickness of 5 to 30 μm, the worked layer with the high energy density having a crushed microstructure wherein a distinction between a crystal grain boundary and a crystal grain is eliminated.

2. An austenitic stainless steel having a chemical composition comprising, by mass %, C: 0.02 to 0.15%, Si: 0.1 to 1.0%, Mn: 0.1 to 2.0%, Cr: 15.0 to 23.0%, Ni: 6.0 to 20.0%, and N: 0.005 to 0.3%, and
one or more kinds selected from Co: not more than 0.8%, Cu: not more than 5.0%, V: not more than 1.5%, Nb: not more than 1.5%, sol. Al: not more than 0.05%, and B: not more than 0.03%, the balance being Fe and impurities, P and S which are impurities being not more than 0.04% and not more than 0.03%, respectively, wherein
a near-surface portion is covered with a worked layer of high energy density having an average thickness of 5 to 30 μm, the worked layer with the high enemy density having a crushed microstructure wherein a distinction between a crystal grain boundary and a crystal grain is eliminated.

3. The austenitic stainless steel according to claim 2, comprising, by mass %, in place of part of Fe, one or more elements selected from following first and second groups:
the first group: Ca: not more than 0.2%, Mg: not more than 0.2%, Zr: not more than 0.2%, and REM: not more than 0.2%; and
the second group: Ti: not more than 1.0%, Ta: not more than 0.35%, Mo: not more than 4.0%, and W: not more than 8.0%.

4. The austenitic stainless steel according to claim 1, wherein
the austenitic stainless steel has an average creep rupture strength of not less than 85 MPa at 700° C. for 10000 hours.

5. The austenitic stainless steel according to claim 2, wherein
the austenitic stainless steel has an average creep rupture strength of not less than 85 MPa at 700° C. for 10000 hours.

6. The austenitic stainless steel according to claim 3, wherein
the austenitic stainless steel has an average creep rupture strength of not less than 85 MPa at 700° C. for 10000 hours.

7. The austenitic stainless steel according to claim 1, wherein
the austenitic stainless steel has an austenite grain size number of not less than seven.

8. The austenitic stainless steel according to claim 1, wherein
a thickness of the worked layer is represented by a thickness which appears as a gray level difference in a microscopic observation of the austenitic stainless steel, after the austenitic stainless steel is heated at 650 to 750° C. for 10 minutes to 10 hours, a cross section thereof including the worked layer is polished, and thereafter the polished surface is electrolytic etched in a 5 to 20% chromic acid solution.

9. The austenitic stainless steel according to claim 7, wherein
a thickness of the worked layer is represented by a thickness which appears as a gray level difference in a microscopic observation of the austenitic stainless steel, after the austenitic stainless steel is heated at 650 to 750° C. for 10 minutes to 10 hours, a cross section thereof including the worked layer is polished, and thereafter the polished surface is electrolytic etched in a 5 to 20% chromic acid solution.

10. The austenitic stainless steel according to claim 1, wherein the austenitic stainless steel is used as a heat-resisting member.

11. The austenitic stainless steel according to claim 7, wherein the austenitic stainless steel is used as a heat-resisting member.

12. The austenitic stainless steel according to claim 8, wherein the austenitic stainless steel is used as a heat-resisting member.

13. The austenitic stainless steel according to claim 9, wherein the austenitic stainless steel is used as a heat-resisting member.

14. An austenitic stainless steel tube comprised of the steel according to claim 1.

15. An austenitic stainless steel tube comprised of the steel according to claim 7.

16. An austenitic stainless steel tube comprised of the steel according to claim 8.

17. An austenitic stainless steel tube comprised of the steel according to claim 9.

18. An austenitic stainless steel tube comprised of the steel according to claim 10.

19. An austenitic stainless steel tube comprised of the steel according to claim 11.

20. An austenitic stainless steel tube comprised of the steel according to claim 12.

21. An austenitic stainless steel tube comprised of the steel according to claim 13.
